(19) United States
(12) Patent Application Publication
(10) Pub. No.: US 2003/0065610 A1
(43) Pub. Date: Apr. 3, 2003

(54) Enabling transfer of energy incentives between entities

(75) Inventors: Michael Wayne Brown, Georgetown, TX (US); Rabindranath Datta, Austin, TX (US); Michael A. Paolini, Austin, TX (US); Newton James Smith, JR., Austin, TX (US)

Correspondence Address: Marilyn Smith Dawkins, International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 09/969,166

(22) Filed: Oct. 2, 2001

(51) Int. Cl. G06F 17/60

(52) U.S. Cl. 705/37

(57) ABSTRACT

A method, system, and program for enabling transfer of energy incentives between entities are provided. At least one client requests energy incentives from at least one authority server. The at least one authority server determines a payment amount for an energy incentive based on energy efficiencies achieved by the at least one client. The authority server then transfers the energy incentive with reference to a payment mechanism for the energy incentive to the at least one client. Advantageously, a single energy incentive may be distributed among multiple qualifying users where applicable.

### CROSS-REFERENCE TO RELATED APPLICATIONS

The present application is related to the following copending applications, incorporated herein by reference:

(1) U.S. patent application Ser. No. ______ (Attorney Docket No. AUS920010695US1);

(2) U.S. patent application Ser. No. ______ (Attorney Docket No. AUS920010696US1);

(3) U.S. patent application Ser. No. ______ (Attorney Docket No. AUS920010697US1);

(4) U.S. patent application Ser. No. ______ (Attorney Docket No. AUS920010698US1);

(5) U.S. patent application Ser. No. ______ (Attorney Docket No. AUS920010699US1);

(6) U.S. patent application Ser. No. ______ (Attorney Docket No. AUS920010700US1);

(7) U.S. patent application Ser. No. ______ (Attorney Docket No. AUS920010702US1);

(8) U.S. patent application Ser. No. ______ (Attorney Docket No. AUS920010703US1);

(9) U.S. patent application Ser. No. ______ (Attorney Docket No. AUS920010705US1);

(10) U.S. patent application Ser. No. ______ (Attorney Docket No. AUS920010706US1);

(11) U.S. patent application Ser. No. ______ (Attorney Docket No. AUS920010707US1); and

(12) U.S. patent application Ser. No. ______ (Attorney Docket No. AUS920010708US1).

### BACKGROUND OF THE INVENTION

1. Technical Field

The present invention relates in general to computer systems and, in particular, to conservation of energy facilitated by computer systems. Still more particularly, the present invention relates to enabling a transfer of energy incentives between multiple entities in response to conservation of energy.

2. Description of the Related Art

Conservation of energy, water, and other resources is of interest globally as resources become more scarce and expensive. More conservative processes for producing products continue to be developed. In addition, products that utilize fewer resources and may be recycled or disposed of efficiently, continue to develop.

However, while more energy conservative products and services may be available, consumers are not always quick to change to energy conservative products for multiple reasons. For example, energy conserving cooling units are available that would reduce electrical bills overall and provide cooler homes, however the initial cost often detracts consumers from installing a more conservative system. Some local governments attempt to persuade citizens to change to more conservative systems by providing rebates for installation of energy conserving products. However, obtaining the rebates typically requires additional steps by the consumer and the rebates may take time to arrive by mail.

On a smaller scale, recyclable products may not be purchased by consumers because of the larger initial cost. Some communities may provide cash incentives for the return of recyclable products, thus reducing the effective cost of the product. However, many other communities sell the same product at the same price with no recycle incentive.

In order to improve conservation, several incentive systems have been developed. For example, U.S. patent application Ser. No. ______ (Attorney Docket No. AUS920010699US1) and U.S. patent application Ser. No. ______ (Attorney Docket No. AUS920010700US1) detail the determination of electronic payment incentives in response to consumer purchases of energy efficient products and services. The electronic payment incentives may be in multiple forms including, but not limited to, credits, rebates, tax rebates, electronic coupons, and other forms of electronic payment.

In order to effectively implement an incentive system, there is a need for efficient transfer of incentives, such that all parties involved, from initial manufacturer to buyer, receive automatic incentives for producing or purchasing energy efficient products or services. Therefore, in view of the foregoing, there is a need for a method, system, and program for transferring electronic incentives between product and service entities in response to energy conservation.

### SUMMARY OF THE INVENTION

In view of the foregoing, it is therefore an object of the present invention to provide an improved computer system.

It is another object of the present invention to provide a method, system and program for conservation of energy facilitated by computer systems.

It is yet another object of the present invention to provide a method, system and program for enabling a transfer of energy incentives between multiple entities.

According to one embodiment of the present invention, at least one client requests energy incentives from at least one authority server. The at least one authority server determines a payment amount for an energy incentive based on energy efficiencies achieved by the at least one client. The authority server then transfers the energy incentive with reference to a payment mechanism for the energy incentive to the at least one client.

According to another embodiment of the present invention, a client is provided for receiving an energy incentive, in response to an energy efficiency achieved by the client. Then, the energy incentive is divided into multiple energy incentives, each associated with one from among multiple qualified users participating in the energy efficiency achieved by the client.

All objects, features, and advantages of the present invention will become apparent in the following detailed written description.

### BRIEF DESCRIPTION OF THE DRAWINGS

The novel features believed characteristic of the invention are set forth in the appended claims. The invention itself s however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which promoting and controlling energy conservation may be performed in accordance with the method, system and program of the present invention;

FIG. 3 depicts a block diagram of multiple types of servers and clients that may be utilized to promote and control conservation of energy in accordance with the method, system, and program of the present invention;

FIG. 4 illustrates a block diagram of an incentive transfer system in accordance with the method, system, and program of the present invention;

FIG. 5 depicts a block diagram of an incentive request in accordance with the method, system, and program of the present invention;

FIG. 6 illustrates a block diagram of an incentive payment in accordance with the method, system, and program of the present invention;

FIG. 7 depicts a block diagram illustrative of a pre-purchase incentive request system in accordance with the method, system, and program of the present invention;

FIG. 8 illustrates a block diagram illustrative of a cumulative incentive system in accordance with the method, system, and program of the present invention;

FIG. 9 illustrates a block diagram of a distribution of a divided energy incentive in accordance with the method, system, and program of the present invention;

FIG. 10 depicts a high level logic flowchart of a process and program determining and distributing an energy incentive in accordance with the method, system, and program of the present invention; and

FIG. 11 illustrates a high level logic flowchart of a process and program for storing an energy incentive in accordance with the method, system, and program of the present invention.

### DETAILED DESCRIPTION OF THE PREFERRED EMBODIMENT

A method, system, and program for enabling transfer of energy incentives between entities are provided. For purposes of the present invention, energy incentives may include, but are not limited to, credits, rebates, tax rebates, electronic coupons, cumulative amounts, and other forms of monetary compensation.

Advantageously, in the present invention, credits and rebates may be transferred as redeemable electronic payments. In particular, tax rebates are advantageously transferred as electronic records of a tax rebate for reference when filing taxes.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computer system may include a portable computing system such as a notebook computer, a palmtop computer, a personal digital assistant, a telephone or other electronic computing system that may also incorporate communications features that provide for telephony, enhanced telephony, messaging and information services. However, the computer system may also include, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

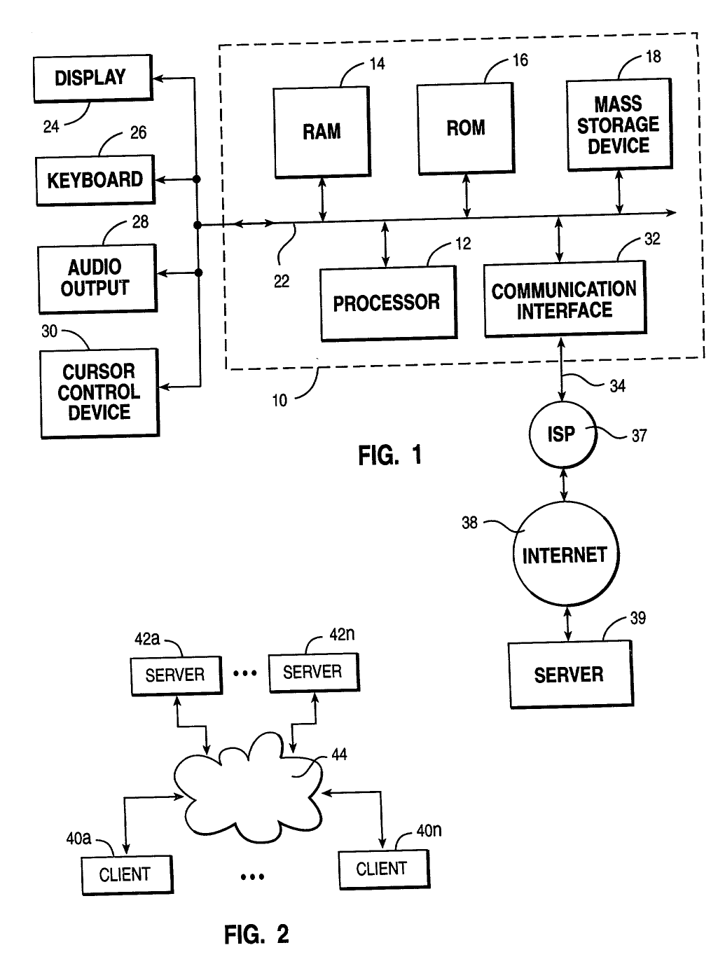

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

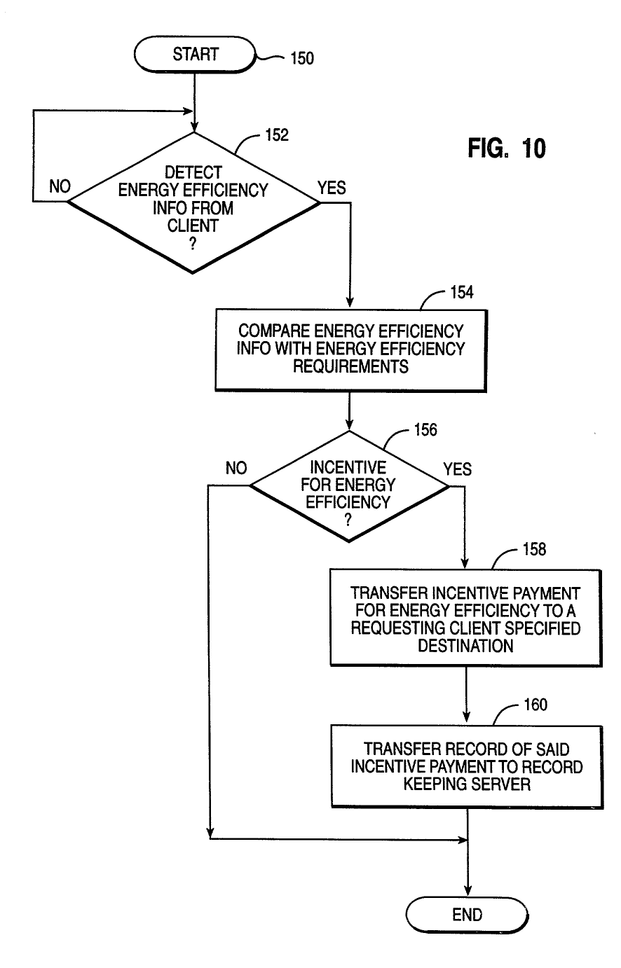

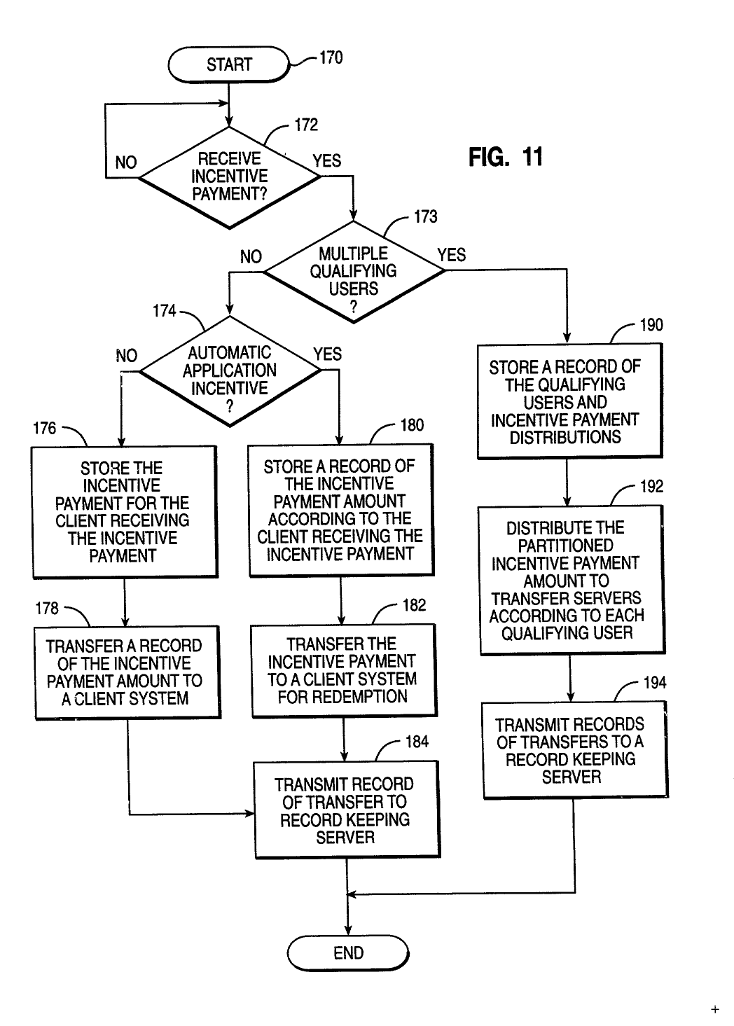

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 10, 11, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Networking Overview

With reference now to FIG. 2, there is depicted a simplified block diagram of a client/server environment in which promoting and controlling energy conservation may be performed in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client system 40a-40n and render Web documents (pages) served by server systems 42a-42n. Additionally, each of client systems 40a-40n and server systems 42a-42n may function as both a “client” and a “server” and may be implemented utilizing a computer system such as computer system 10 of FIG. 1.

The Web may refer to the total set of interlinked hypertext documents residing on servers all around the world. Network 44, such as the Internet, provides an infrastructure for transmitting these hypertext documents between server systems 42a-42n and client systems 40a-40n. Documents (pages) on the Web may be written in multiple languages, such as Hypertext Markup Language (HTML) or Extensible Markup Language (XML), and identified by Uniform Resource Indicators (URIs) that specify the particular server and pathname by which a file can be accessed, and then transmitted from that server to an end user utilizing a protocol such as Hypertext Transfer Protocol (HTTP). Web pages may further include text, graphic images, movie files, and sounds as well as Java applets and other small embedded software programs that execute when the user activates them by clicking on a link.

It is advantageous in the present invention to utilize both wireless and wired network connections to network 44. Wireless network connections may be implemented utilizing Bluetooth™ or other long or short distance radio frequency broadcasting or infrared transmissions. Advantageously, whether wireless or wired network connections are utilized, multiple types of encryption security features may be utilized to protect transmission of incentives, as will be understood by one skilled in the art.

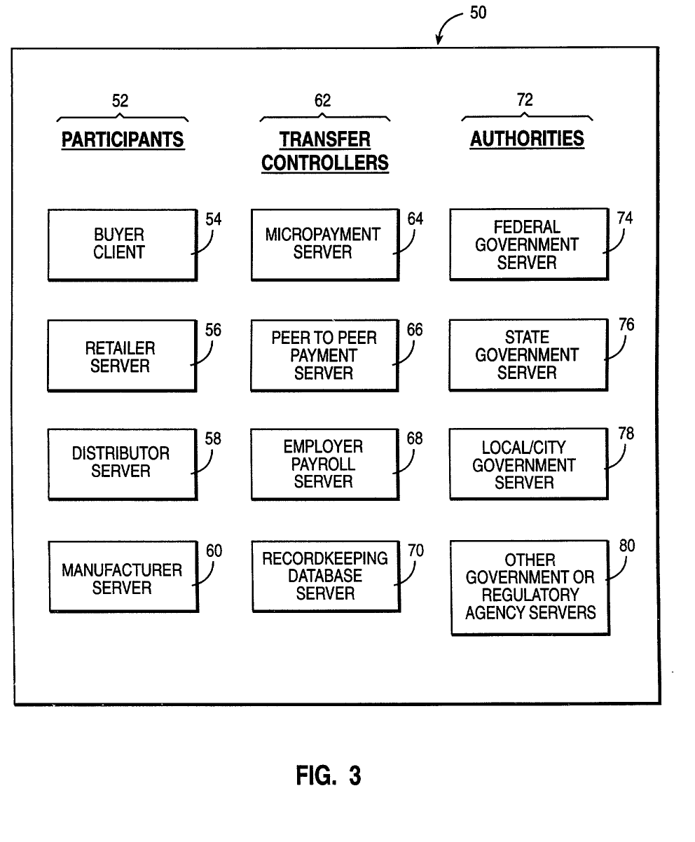

Referring now to FIG. 3, there is depicted a block diagram of multiple types of servers and clients that may be utilized to promote and control conservation of energy in accordance with the method, system, and program of the present invention. As illustrated, multiple client and server elements 50 are divided according to category. In the present embodiment categories include, but are not limited to, participants 52, transfer controllers 62, and authorities 72.

Participants 52 advantageously include all levels of people, businesses, and corporations involved in energy conservation. In the present embodiment, participants 52 include, but are not limited to, a buyer client 54, a retailer server 56, a distributor server 58, and a manufacturer server 60. Advantageously, in the present invention, incentives may be provided to buyers, retailers, distributors, and manufacturers to encourage purchase, sale, use, and manufacture of more energy efficient products and services.

Transfer controllers 62 advantageously include all levels of controllers provided for transferring monetary amounts as energy incentives, in response to conservation or lack of conservation by at least one of participants 52. In the present embodiment, transfer controllers 62 include, but are not limited to, a micropayment server 64, a peer-to-peer payment server 66, an employer payroll server 68, and a recordkeeping database server 70. In the present invention, product incentives may be transferred to and from any of transfer controllers 62 in the form of an electronic payment, rebate, coupon, record or other payment type.

Authorities 72 advantageously include all levels of government and policy setting groups that may be provided for setting policy and standards to determine energy incentives in response to conservation or lack of conservation by at least one of participants 52. In the present example, authorities 72 specifically includes federal government (govt) server 74, state government server 76, local/city government server 78, and other government or regulatory agency servers 80. In addition, authorities 72 may include businesses and other non-governmental organizations.

### Transferring Energy Incentives Context

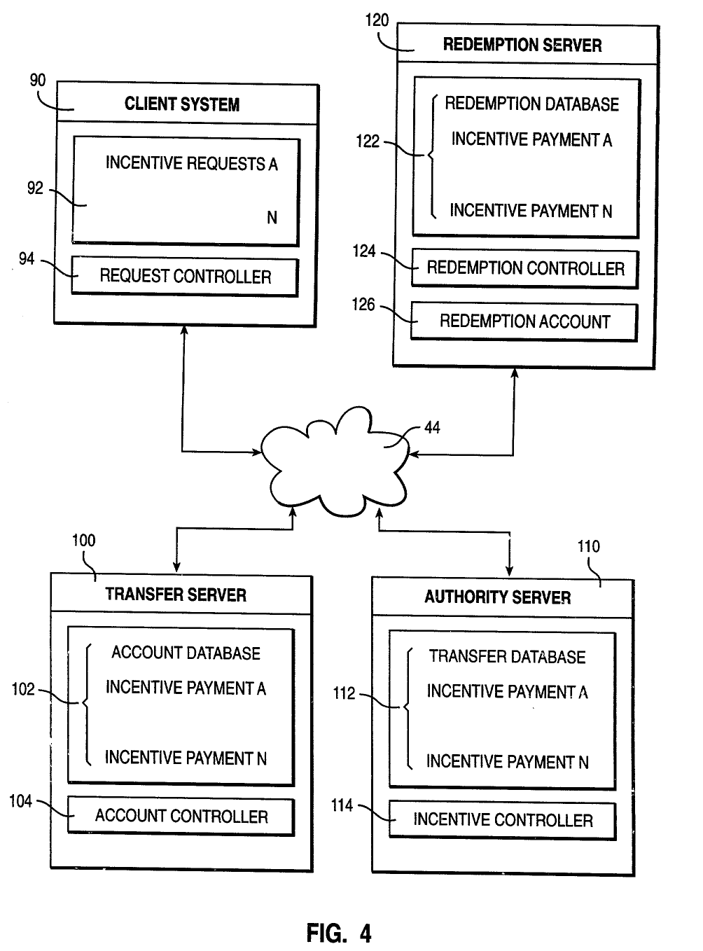

With reference now to FIG. 4, there is depicted a block 2S diagram of an incentive transfer system in accordance with the method, system, and program of the present invention. As illustrated, multiple systems are communicatively connected via network 44.

A client system 90 transmits requests for incentives according to energy efficiency information. An incentive requests database 92 includes incentive requests A-N. Each incentive request preferably indicates the requesting system (here, client system 90), the receiving system, and the energy efficiencies. The receiving system may include client system 90 and transfer system 100. Request controller 94 advantageously controls the specification and transmission of each incentive request to the appropriate authority system, such as authority server 110. Although not depicted, particularly where client system 90 is a retailer or distributor, client system 90 may include an account database for requesting and storing incentives prior to purchase by a consumer for items available from the retailer or distributor. Where the pre-purchase incentives include electronic coupons, client system 90 may apply the incentive value to purchases and later transmit multiple incentives to be redeemed in bulk.

A transfer server 100 advantageously receives energy incentives for a particular user or group of users. In particular, transfer server 100 may include an account database 102 and an account controller 104. Account database 102 advantageously maintains a current balance for a user by recording energy incentive payments A-N received for the user. 25 Account controller 104 advantageously controls accesses to account database 102 for adding energy incentive payments or deducting from the current balance. Advantageously, a single transfer server may maintain accounts for multiple users.

According to one advantage of the present invention, transfer server 100 may represent a micropayment server, a peer-to-peer server, an employer payroll server, or a recordkeeping server. Further, multiple transfer server may be involved in the transfer of energy incentive payments.

Advantageously, where transfer server 100 is a micropayment server, the account maintained within account database 102 may be utilized to pay for products or services offered by the authority providing the energy incentives. In addition, a micropayment server transfers micropayments from one individual or entity to another. In particular, micropayments may include monetary amounts or may represents credits, energy usage, or other units of measure that may be utilized to determine an energy incentive.

According to one advantage of the present invention, an energy incentive may be distributed among multiple people, where multiple people are responsible for achieving a particular energy efficiency. For example, where an energy incentive is distributed for carpooling, the energy incentive may be divided into micropayments transferred to a micropayment server, where the micropayments are distributed as portions of the energy incentive to each of the occupants of the vehicle.

In another example, an energy incentive may be distributed as micropayments to the accounts of all people riding a subway or other transportation in lieu of driving a vehicle. Preferably, an identification number or other payment code would be received from each person entering the subway to pay for using the subway. The micropayment incentives may be distributed in association with the identification number before, during, or after a ride and may be applied to a current ride cost or future ride costs.

According to another advantage of the present invention, an energy payment may be made by multiple people to a person or entity for use of energy. For example, where passengers are carpooling, each of the passengers in the vehicle may make a micropayment from a micropayment server to the owner or driver of the vehicle in order to compensate the owner of the vehicle for use during carpooling. A vehicle owner may charge, for example, $0.05 per mile, such that as each passenger enters and exits the vehicle, the riding mileage is calculated and a micropayment made to the driver for the mileage. Alternatively, a vehicle owner may charge each of the passengers a ride in that passenger's vehicle during a carpool, such that carpooling uses are tallied according to vehicle owner and passengers.

In another example, where multiple employees are sharing a conference room, the energy usage for the conference room may be distributed among the employees as a micropayment value representing energy usage. Then, energy incentives for energy efficient use of company resources by employees will be calculated, including the portion of energy usage apportioned to an employee for use of the conference room.

Where transfer server is a peer-to-peer server, the account maintained within account database 102 may be utilized to pay for products and services external to the authority providing the energy incentives. One example of a peer-to-peer system is Paypal™. A peer-to-peer server may also be implemented in the above examples, such that monetary payments are directly transferred between parties.

In particular, where energy incentives and energy usage costs are divided among multiple people, the amounts may be distributed via multiple types of server systems, depending on the type of payment requested by each person. For example, where a carpooling incentive is distributed among multiple occupants of a vehicle, some occupants may request that the incentive be received as a micropayment that may be applied to other vehicle costs, while other occupants may request that the incentive be received a direct monetary payment to a peer-to-peer server.

Where transfer server 100 is an employer payroll server, the account maintained within account database 102 may be utilized to determine a paycheck amount for an employee. Therefore, energy incentives may be further distributed from the employer payroll server. In particular, businesses may provide energy incentives to employees for efficient energy usage, where those energy incentives are directly applied to a paycheck to the employees.

Where transfer server 100 is a record keeping database, the account maintained within account database 102 is a record of incentives for a user. Preferably, records are made of all energy incentives for a user regardless of the type of payment utilized for transfer of the incentive. In particular, where tax rebates are provided as an incentive payment, the tax rebate is stored as a record within account database 102. Then, at the end of a taxing period, the tax rebates may be applied to a total tax amount to reduce a user's taxes.

An authority server 110 advantageously determines and distributes energy incentives for a particular user or group of users. In particular, authority server 110 may include a transfer database 112 and an incentive controller 114. Account database 112 maintains records of energy incentives A-N that have been distributed to a user. Incentive controller 114 advantageously controls distribution of energy incentive payments from authority server 110 to the appropriate transfer server according to type of energy incentive, user receiving the energy incentive, and types of transfer servers available for a user.

According to one advantage of the present invention, authority server 110 may calculate energy incentives for users for multiple types of energy conservation. Energy conservation and energy incentives may include, but are not limited to, the types of energy conservation described in U.S. patent Ser. No. ______ (Atty. Docket AUS920010695US1), U.S. patent Ser. No. ______ (Atty. Docket AUS920010696US1), U.S. patent Ser. No. ______ (Atty. Docket AUS920010697US1), U.S. patent Ser. No. ______ (Atty. Docket AUS920010698US1), U.S. patent Ser. No. ______ (Atty. Docket AUS920010699US1), U.S. patent Ser. No. ______ (Atty. Docket AUS920010700US1), U.S. patent Ser. No. ______ (Atty. Docket AUS920010702US1), U.S. patent Ser. No. ______ (Atty. Docket AUS920010703US1), U.S. patent Ser. No. ______ (Atty. Docket AUS920010704US1), U.S. patent Ser. No. ______ (Atty. Docket AUS920010705US1), U.S. patent Ser. No. ______ (Atty. Docket AUS920010706US1), and U.S. patent Ser. No. ______ (Atty. Docket AUS920010707US1), herein incorporated by reference.

A redemption server 120 is depicted for providing the monetary backing for incentives. While in the present embodiment redemption server 120 is illustrated as independent of authority server 110, in alternate embodiments, redemption server 120 and authority server 110 may be incorporated within the same server system.

Redemption server 120 includes a payment database 122, a payment controller 124, and an account 126. Payment database 122 includes the incentive payments A-N that have been redeemed by redemption server 120. Payment controller 124 is a payment mechanism for controlling the redemption of incentive payments AN from account 126. In particular, when an incentive is received at redemption server 120 for payment, payment controller 124 preferably verifies the incentive from authority server 110 or a recordkeeping server.

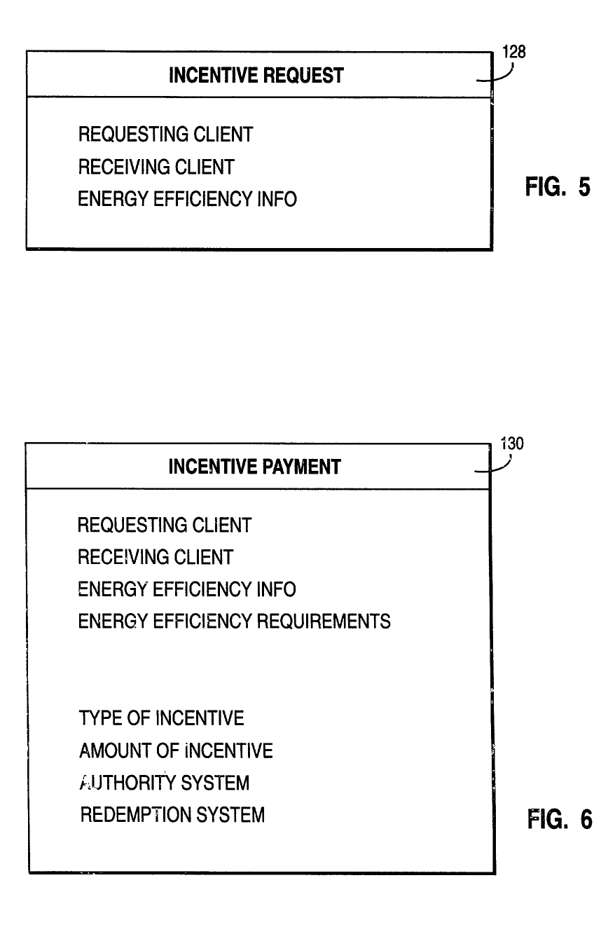

Referring now to FIG. 5, there is depicted a block diagram of an incentive request in accordance with the method, system, and program of the present invention. An incentive request 128 includes multiple types of information including, but not limited to, a requesting client, a receiving client and the energy efficiency information.

Preferably, the requesting client indicates the system and particular user requesting the incentive. The receiving client indicates the system and particular user that is to receive an incentive. For example, a particular transfer system may be indicated as the receiving client with an identifier for the user account within the transfer system also provided. The energy efficiency information may include multiple types of energy efficiency information depending on the type of energy being measured.

In particular, the receiving client may be left empty when requested as a pre-purchase incentive, may include a client identifier, or may include multiple qualifying client identifiers. Where multiple qualifying client identifiers are provided, a single incentive payment to be divided among the qualifying clients or multiple incentive payments already divided by the qualifying clients may be returned.

Referring now to FIG. 6, there is illustrated a block diagram of an incentive payment in accordance with the method, system, and program of the present invention. An incentive payment 130 includes multiple types of information including, but not limited to, a requesting client, a receiving client, energy efficiency information, energy efficiency requirements, the type of incentive, the amount of the incentive, the authority system from which the incentive is granted, and the redemption system providing monetary backing for the incentive. In alternate embodiments, other types of information may be included in incentive payment 130.

In some cases, the client requesting an energy incentive may be different from the client ultimately receiving an energy incentive. For example, where a business requests an energy incentive for a particular product or service prior to sale, the client requesting the energy incentive is the business, however, the client receiving the energy incentive is preferably the buyer. Advantageously, when a buyer purchases the product or service, the buyer's information is inserted in incentive payment 130.

Advantageously, an authority server may track the path of incentive payment 130, such that if adjustments are made to incentive payment 130, the authority server is notified of the adjustments. For example, adjustments may be made in the receiving client when incentive payment 130 is received by the client enabled to redeem the incentive. In addition, adjustments may be made in the receiving client when incentive payment 130 is redeemed.

According to one advantage of the present invention, multiple types of incentives may be provided. First, the types of incentives may be distinguished by those incentives that are automatically applicable and those incentives that are delayed. Incentives that are automatically applicable typically include monetary incentives, electronic coupons, and tax rebates that are utilized to adjust the price of a product or service at the point of sale. Delayed incentives are those that are redeemable after the point of sale and include incentives such as rebates and cumulative incentives.

Some incentive payments, such as a monetary incentives, include a direct transaction of a monetary payment from the authority system to the receiving client. Other incentives may represent a monetary amount that is redeemable from the authority providing the incentive or from an alternate redemption system. For example, an electronic coupon type of incentive payment represents a monetary amount that is redeemable from a redemption system.

Other incentive payments, such as cumulative incentives, represent an incremental amount that when accumulated may be redeemed for a monetary amount. For example, a cumulative incentive type of incentive payment may include an “amount of incentive” as a point or other incremental system. When a user accumulates a particular number of points, the user may receive a rebate on a service charge or a reduction in the cost of a service, such as health care insurance or vehicle registration.

Further, some incentives payments may be apportioned between multiple qualifying users, where each of the qualifying users participated in achieving a particular energy incentive. As the incentive payment is apportioned to qualifying receiving clients, the record of the incentive payment is preferably updated.

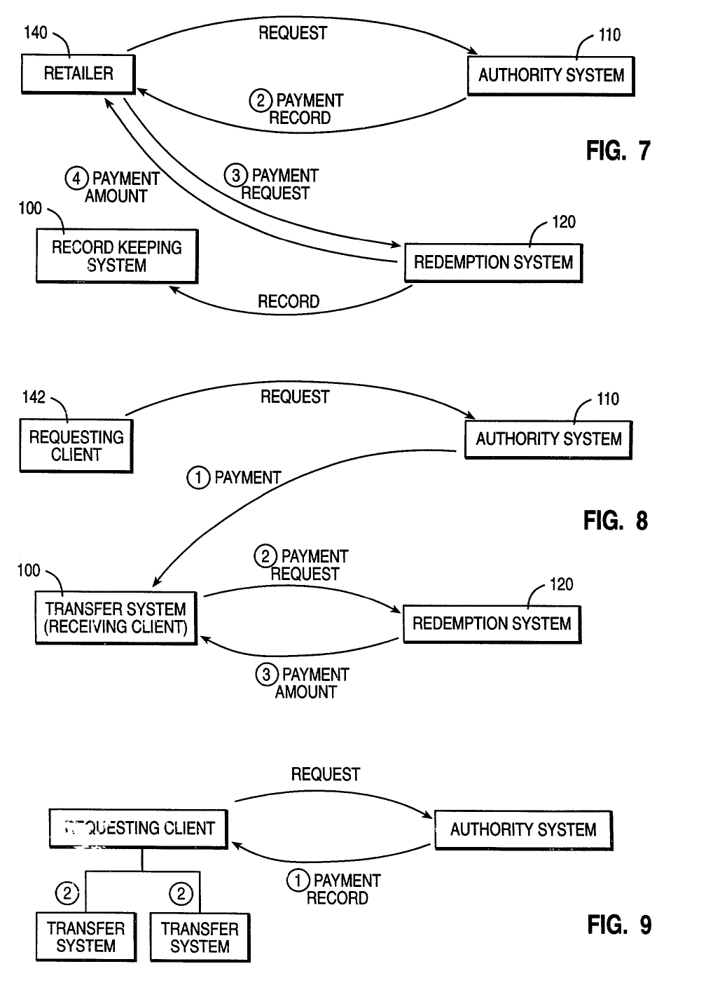

With reference now to FIG. 7, there is depicted a block diagram illustrative of a pre-purchase incentive request system in accordance with the method, system, and program of the present invention. When requesting pre-purchase incentives, preferably automatically applicable incentives are received. In particular, automatically applicable incentives are typically in the form of a flat monetary incentive or electronic coupon.

As illustrated, an incentive payment is transmitted from authority system 110 to retailer system 140 in response to an incentive request by retailer server 140. If the incentive payment is a monetary incentive, then retailer server 140 holds the incentive payment in an account to be applied to a future purchase by a client. If the incentive payment is an electronic coupon, then retailer server 140 transmits the incentive payment to a redemption system 120 for redemption of the electronic coupon. The payment for the redemption of the electronic coupon is transmitted to retailer server 140 and stored to be applied to a future purchase by a client. In particular, retailer server 140 functions as a transfer server in addition to requesting the incentive.

When a client purchases the product or service to which the incentive payment is associated, the incentive is applied to the client's bill. In addition, the incentive payment is updated by retailer server 140 to indicate the client receiving the incentive and a record of the adjustment to the incentive payment is transferred to transfer server 100. In the present example, transfer server 100 is a recordkeeping server system.

While in the present example, retailer server 140 is described as receiving pre-purchase incentives, in alternate embodiments, alternate types of systems may request and receive pre-purchase incentives.

Referring now to FIG. 8, there is depicted a block diagram illustrative of a cumulative incentive system in accordance with the method, system, and program of the present invention. Advantageously, a user may receive cumulative incentives that when accumulated to a particular threshold, may be redeemed for a monetary incentive.

As illustrated, a client system 142 transfers energy efficiency information to authority 110. Authority 110 determines a cumulative incentive and transmits the incentive to transfer server 100. Transfer server 100 preferably includes an account for storing cumulative incentives. When a particular threshold is accumulated of cumulative incentives, the cumulative incentives are transferred to redemption system 120. Redemption system 120 determines an incentive payment for the cumulative incentives and returns the incentive payment to transfer server 100 or authority system 110. In particular, where a monetary incentive is provided from redemption server 120, it is advantageous to transfer the monetary incentive to transfer server 100 for addition to a user account. However, where the incentive is for a rebate or reduction of a cost of a product or service provided by authority server 110, then it is advantageous to transfer the incentive to authority server 110, where authority serve 110 adjusts a bill for a client according to the incentive.

With reference now to FIG. 9, there is depicted a block diagram of a distribution of a divided energy incentive in accordance with the method, system, and program of the present invention. Advantageously, a single energy incentive may be divided according to the number of qualifying users.

As illustrated, a requesting client 144 transfers energy efficiency information to authority system 110. Authority system 110 determines an incentive according to the energy efficiency information and transfers the incentive payment back to requesting client 144. Requesting client 144 then divides the single energy incentive payment according to the qualified users and distributes the divided incentive payments to transfer servers 100a-100n for each of the qualified users. Transfer servers 100a-100n may then redeem the divided incentive payments at a redemption system. In addition, the divided energy incentive payments may be transferred to a single transfer server for each of the qualified users.

Alternatively, in transferring energy efficiency information to authority system 110, requesting client 144 may also designate the qualifying users, such that authority system 110 will apportion the incentive payment according to the qualifying users. For example, where an energy incentive payment is divided among multiple passengers of a vehicle, authority system 110 may determine the portion of an energy incentive assignable to each of the qualifying passengers according to additional incentive criteria, such as whether a passenger is a government employee.

Further, in a reverse system, each qualifying user may make a payment to requesting client 144 for use of a resource attributed to requesting client 144. Each of transfer systems 100a-100n may transfer a payment to requesting client 144. Requesting client 144 may then transfer those payments to an alternate transfer system associated with requesting client 144. In addition, transfer systems 100a-100n may also directly transfer the payments to that transfer system associated requesting client 144.

In cases where authority system 110 may charge requesting client 144 for inefficient energy usage or other charges associated with energy usage, the payments made by transfer systems 100a-100n to requesting client 144 will preferably balance the charge made. For example, where a carpool vehicle passes through a tollway, the vehicle bearing the toll sticker is charged for the usage. However, each of the passengers in the vehicle may make an automatic micropayment to the vehicle's tollway account to pay for a portion of the toll. In another example, where multiple employees use another employee's office for meeting and working, the multiple employees preferably transfer a micropayment to the employee's office to compensate for the energy usage by the multiple employees.

Referring now to FIG. 10, there is illustrated a high level logic flowchart of a process and program determining and distributing an energy incentive in accordance with the method, system, and program of the present invention. As illustrated, the process starts at block 150 and thereafter proceeds to block 152.

Block 152 depicts a determination as to whether or not energy efficiency information is detected from a client. If energy efficiency information is not detected from a client, then the process iterates at block 152. If energy efficiency information is detected from a client, then the process passes to block 154.

Block 154 illustrates comparing the energy efficiency information with energy efficiency requirements. Next, block 156 depicts a determination as to whether or not an incentive is available for the energy efficiency information in view of the energy efficiency requirements. If an energy incentive is not available, then the process ends. If an energy incentive is available, then the process passes to block 158.

Block 158 depicts transferring the incentive payment for energy efficiency to a system specified by the requesting client. The system specified by the requesting client may include a transfer server, an authority server, a retailer server, or a redemption server. Next, block 160 illustrates transferring a record of the incentive payment to a record keeping server, and the process ends.

Referring now to FIG. 11, there is illustrated a high level logic flowchart of a process and program for storing an energy incentive in accordance with the method, system, and program of the present invention. As depicted, the process starts at block 170 and thereafter proceeds to block 172.

Block 172 depicts a determination as to whether an incentive payment is received. If an incentive payment is not received, then the process iterates at block 172. If an incentive payment is received, then the process passes to block 173.

Block 173 depicts a determination as to whether or not the incentive payment applies to multiple qualifying users. In particular, where an incentive payment applies to multiple qualifying users, the incentive payment is divisible among those users. If the incentive payment does not apply to multiple qualifying users, then the process passes to block 174. If the incentive payment does apply to multiple qualifying users, then the process passes to block 190.

Block 174 illustrates a determination as to whether or not the incentive is automatically applicable. If the incentive is automatically applicable, then the process passes to block 180. If the incentive is not automatically applicable, then the process passes to block 176.

Block 176 depicts storing the incentive payment for the client receiving the incentive payment. Next, block 178 illustrates transferring a record of the incentive payment amount to a client system, and the process passes to block 184.

Block 180 illustrates storing a record of the incentive payment amount according to the client receiving the incentive payment. Next, block 182 depicts transferring the incentive payment to a client system for redemption. Thereafter, block 184 illustrates transmitting a record of the transfer to the record keeping server, and the process ends. 10

Block 190 depicts storing a record of the qualifying users and the incentive payment distribution. The incentive payment may be distributed according to qualifying user prior to receipt at the receiving client or may be distributed by the receiving client. Next, block 192 illustrates transferring the incentive payment amount to transfer servers according to each qualifying user. Thereafter, block 194 depicts transmitting records of the transfers to the recordkeeping server, and the process ends.

While the invention has been particularly shown and described with reference to a preferred embodiment, it will be understood by those skilled in the art that various changes in form and detail may be made therein without departing from the spirit and scope of the invention.

What is claimed is:

1. A system for enabling transfer of energy incentives between entities, said system comprising:
at least one client requesting an energy incentive for achieving a particular energy efficiency;
a payment mechanism;
at least one authority server for receiving said request from said at least one client; and
said at least one authority server further comprising:
means for calculating a payment amount for said energy incentive according to said particular energy efficiency; and
means for transferring said energy incentive with reference to said payment mechanism to said at least one client.

2. The system for enabling transfer of energy incentives according to claim 1, wherein said plurality of clients include at least one from among a buyer, a retailer, a distributor, and a manufacturer.

3. The system for enabling transfer of energy incentives according to claim 1, wherein said payment mechanism is an authority system that directly attaches said payment amount to said energy incentive.

4. The system for enabling transfer of energy incentives according to claim 1, wherein said payment mechanism is a redemption system that redeems said payment amount to said at least one of said plurality of clients.

5. The system for enabling transfer of energy incentives according to claim 1, wherein said payment amount is at least one from among automatically applicable to a purchase cost, delayed in application to a purchase cost, delayed in application to a tax cost, applicable to a payroll amount, cumulative at a storage location, and apportioned among multiple users.

6. A method for enabling transfer of energy incentives between entities, said method comprising the steps of:
receiving, from a client entity, a request for an energy incentive corresponding to a user achieving a particular energy efficiency;
determining, at an authority entity, a payment amount for said energy incentive according to said particular energy efficiency compared with energy efficiency requirements;
transferring said energy incentive to a transfer server associated with said client entity, such that said energy incentive is transferred between entities.

7. The method for enabling transfer of energy incentives according to claim 6, said step of receiving, from a client entity, further comprising the step of:
receiving said request for an energy incentive from said client entity comprising at least one from among a buyer, a retailer, a distributor, and a manufacturer.

8. The method for enabling transfer of energy incentives according to claim 6, said method further comprising the step of:
redeeming said energy incentive at a redemption server.

9. The method for enabling transfer of energy incentives according to claim 6, said step of transferring said energy incentive to a transfer server further comprising the step of:
transferring said energy incentive to a transfer server for storage as a pre-purchase energy incentive.

10. The method for enabling transfer of energy incentives according to claim 6, said step of transferring said energy incentive to a transfer server further comprising the step of:
transferring said energy incentive to a transfer server for accumulation with a plurality of accumulable energy incentives, wherein said plurality of accumulable energy incentives are redeemable once accumulating to a minimum amount.

11. The method for enabling transfer of energy incentives according to claim 6, said step of transferring said energy incentive to a transfer server further comprising the step of:
transferring said energy incentive to a transfer server for immediate application to a purchase price.

12. A program for enabling transfer of energy incentives between entities, residing on a computer usable medium having computer readable program code means, said program comprising:
means for enabling receipt of a request for an energy incentive corresponding to a user achieving a particular energy efficiency;
means for computing a payment amount for said energy incentive according to said particular energy efficiency compared with energy efficiency requirements;
means for controlling transmission of said energy incentive to a transfer server associated with said client entity, such that said energy incentive is transferred between entities.

13. The program for enabling transfer of energy incentives according to claim 12, said program further comprising:
means for enabling receipt of said request for an energy incentive from said client entity comprising at least one from among a buyer, a retailer, a distributor, and a manufacturer.

14. The method for enabling transfer of energy incentives according to claim 12, said program further comprising:
means for redeeming said energy incentive at a redemption server.

15. The program for enabling transfer of energy incentives according to claim 12, said program further comprising:
means for controlling transmission of said energy incentive to a transfer server for storage as a pre-purchase energy incentive.

16. A method for distributing a single energy incentive, said method comprising the steps of:
receiving an energy incentive, in response to an energy efficiency achieved by a client; and
dividing said energy incentive into a plurality of energy incentives each associated with one from among a plurality of qualified users participating in said energy efficiency achieved by said client.

17. The method for distributing a single energy incentive according to claim 16, said method further comprising the step of:
distributing said plurality of energy incentives to at least one transfer system associated with said plurality of qualified users.

18. The method for distributing a single energy incentive according to claim 16, said method further comprising the step of:
transmitting information about said plurality of qualified users to an authority system; and
receiving said energy incentive assigned to said plurality of qualified users from said authority system.

19. A system for distributing a single energy incentive, said system comprising:
a client for receiving an energy incentive, in response to an energy efficiency achieved by said client; and
means for dividing said energy incentive into a plurality of energy incentives each associated with one from among a plurality of qualified users participating in said energy efficiency achieved by said client.

20. The system for distributing a single energy incentive according to claim 19, said system further comprising:
means for distributing said plurality of energy incentives to at least one transfer system associated with said plurality of qualified users.

21. The system for distributing a single energy incentive according to claim 19, said system further comprising:
means for transmitting information about said plurality of qualified users to an authority system; and
means for receiving said energy incentive assigned to said plurality of qualified users from said authority system.

22. A program for distributing a single energy incentive, residing on a computer usable medium having computer readable program code means, said program comprising:
means for enabling receipt of an energy incentive, in response to an energy efficiency achieved by a client; and
means for dividing said energy incentive into a plurality of energy incentives each associated with one from among a plurality of qualified users participating in said energy efficiency achieved by said client.

23. The program for distributing a single energy incentive according to claim 22, said program further comprising:
means for controlling distribution of said plurality of energy incentives to at least one transfer system associated with said plurality of qualified users.

24. The program for distributing a single energy incentive according to claim 22, said program further comprising:
means for controlling transmission of information about said plurality of qualified users to an authority system; and
means for enabling receipt of said energy incentive assigned to said plurality of qualified users from said authority system.

25. A method for redeeming an energy incentive, said method comprising the steps of:
receiving a request for redemption of an energy incentive authorized by at least one authority; and
redeeming said energy incentive with a financial payment according to a type of said energy incentive and an amount of said energy incentive to at least one from among a receiving client and a requesting client, such that a plurality of unique energy incentives distributed by said at least one authority are redeemable.

26. A system for redeeming an energy incentive, said system comprising:
a redemption system communicatively connected to a network;
said redemption system further comprising:
means for receiving a request, via said network, for redemption of an energy incentive authorized by at least one authority; and
means for redeeming said energy incentive according to a type of said energy incentive and an amount of said energy incentive to at least one from among a receiving client and a requesting client.

27. A program for redeeming an energy incentive, residing on a computer usable medium having computer readable program code means, said program comprising:
means for enabling receipt of a request for redemption of an energy incentive authorized by at least one authority; and
means for controlling redemption of said energy incentive with a financial payment according to a type of said energy incentive and an amount of said energy incentive to at least one from among a receiving client and a requesting client.
